(19) United States
(12) Patent Application Publication
(10) Pub. No.: US 2016/0161828 A1
(43) Pub. Date: Jun. 9, 2016

(54) CAMERA MODULE

(71) Applicant: Samsung Electro-Mechanics Co., Ltd., Suwon-si (KR)

(72) Inventor: Dong Kyun LEE, Suwon-si (KR)

(73) Assignee: Samsung Electro-Mechanics Co., Ltd., Suwon-si (KR)

(21) Appl. No.: 14/949,098

(22) Filed: Nov. 23, 2015

(30) Foreign Application Priority Data
Dec. 8, 2014 (KR) 10-2014-0175275

(51) Int. Cl. G03B 3/10; G02B 7/04

(52) U.S. Cl. CPC G03B 3/10; G02B 7/04

(57) ABSTRACT

A camera module includes: a lens barrel including one or more lenses; a housing accommodating the lens barrel in an internal space thereof; and a piezoelectric actuator disposed on an inner surface of the housing and coupled to the inner surface of the housing through magnetic force, the piezoelectric actuator being configured to drive the lens barrel in an optical axis direction in the internal space.

### CROSS-REFERENCE TO RELATED APPLICATION(S)

This application claims the benefit of Korean Patent Application No. 10-2014-0175275 filed on Dec. 8, 2014 in the Korean Intellectual Property Office, the entire disclosure of which is incorporated herein by reference for all purposes.

### BACKGROUND

1. Field

The following description relates to a camera module.

2. Description of Related Art

Generally, digital cameras, devices in which light incident through lenses is converted into digital signals by an image sensor (a charge coupled device (CCD) and a complementary metal-oxide semiconductor (CMOS)) to store and output images, have been used in several fields such as the mobile device field.

The digital camera as described above has adopted functions such as auto-focusing (AF), optical zooming, shuttering, hand-shake correcting, and the like, and thus user convenience is improved. Specifically, in a case of a digital camera mounted in a mobile device, substantial research has been conducted into auto-focusing and optical zooming in accordance with an increase in the number of pixels of an image sensor.

A conventional lens driving module of a camera includes a housing, a lens barrel to which lenses are coupled, a driving unit moving the lens barrel in an optical axis direction, and a spring fixing the driving unit and the lens barrel. Examples of the driving unit of the lenses include a stepping motor, a voice coil motor (VCM), a piezoelectric ultrasonic motor, or the like. Among them, the piezoelectric ultrasonic motor converts simple vibrations such as contraction and expansion, or the like, generated when electricity is applied to a piezoelectric actuator into circular or linear movement by friction between a stator and a mover (or a rotor), and has advantages in that noise at the time of an operation thereof is not present, and an influence of an electromagnetic wave is not present. Furthermore, the piezoelectric ultrasonic motor provides higher energy density, faster response speed, higher position precision and an off-power holding function as compared with an electromagnetic driving motor.

The piezoelectric ultrasonic motor, the driving unit, is disposed in a direction coinciding with an optical axis direction of the lens barrel. Therefore, when an ultrasonic signal is applied to the driving unit, an auto-focus (AF) function in which the piezoelectric actuator moves the lens barrel while being contracted and expanded in the optical axis direction may be implemented.

U.S. Patent Application Publication No. 2010-0150545 discloses a structure of a camera module.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

According to one general aspect of, a camera module includes: a lens barrel including one or more lenses; a housing accommodating the lens barrel in an internal space thereof; and a piezoelectric actuator disposed on an inner surface of the housing and coupled to the inner surface of the housing through magnetic force, the piezoelectric actuator being configured to drive the lens barrel in an optical axis direction in the internal space.

The piezoelectric actuator may include a magnetic member coupling the piezoelectric actuator to the inner surface of the housing through the magnetic force.

The camera module may further include a magnetic member disposed on an inner surface of the housing and coupling the inner surface of the housing to the piezoelectric actuator through the magnetic force.

The piezoelectric actuator may include: a rod formed of the magnetic member and configured to transfer driving force to the lens barrel in the optical axis direction; and a piezoelectric element coupled to one end of the rod in order to generate the driving force of the rod.

The piezoelectric actuator may include a rod configured to transfer driving force to the lens barrel in the optical axis direction, and a piezoelectric element coupled to one end of the rod in order to generate the driving force of the rod. The magnetic member may be coupled to a side surface of the rod corresponding to the inner surface of the housing.

The rod and the magnetic member may be formed integrally with each other.

The piezoelectric actuator may further include a weighted body disposed on an end of the piezoelectric element opposing one end of the piezoelectric element on which the rod is disposed.

The magnetic member may be formed integrally with the housing by insert injection molding.

The camera module may further include first and second magnetic members disposed on the piezoelectric actuator and the inner surface of the housing, respectively, so as to couple the piezoelectric actuator and the housing to each other through the magnetic force, wherein the first and second magnetic members have opposite poles so that attractive force acts between the first and second magnetic members.

The piezoelectric actuator may be coupled to an outer surface of the lens barrel through magnetic force.

The piezoelectric actuator may include: a rod configured to transfer driving force to the lens barrel in the optical axis direction; a piezoelectric element coupled to one end of the rod in order to generate the driving force of the rod; and a magnetic member coupled to a side surface of the rod corresponding to the outer surface of the lens barrel.

The piezoelectric actuator may include a magnetic member configured to couple the piezoelectric actuator to the outer surface of the lens barrel.

The camera module may further include: first and second magnetic members disposed on the piezoelectric actuator and the outer surface of the lens barrel, respectively, so as to couple the piezoelectric actuator and the lens barrel to each other through the magnetic force, wherein the first and second magnetic members have opposite poles so that attractive force acts between the first and second magnetic members.

According to another general aspect, a camera module includes: a lens barrel including one or more lenses; a housing accommodating the lens barrel in an internal space thereof; and a piezoelectric actuator disposed on an outer surface of the lens barrel and coupled to the outer surface of the lens barrel by magnetic force, the piezoelectric actuator being configured to drive the lens barrel in an optical axis direction in the internal space.

The piezoelectric actuator may include a magnetic member configured to couple the piezoelectric actuator to the outer surface of the lens barrel.

The camera module may further include: first and second magnetic members disposed on the piezoelectric actuator and the outer surface of the lens barrel, respectively, so as to couple the piezoelectric actuator and the lens barrel to each other through the magnetic force, wherein the first and second magnetic members have opposite poles so that attractive force acts between the first and second magnetic members.

Other features and aspects will be apparent from the following detailed description, the drawings, and the claims.

### BRIEF DESCRIPTION OF THE DRAWINGS

FIG. 1 is a perspective view of a camera module, according to an example.

FIG. 2 is an exploded perspective view of the camera module of FIG. 1.

FIG. 3 is an exploded perspective view of a lens barrel assembly and a housing which are coupled to each other, according to an example.

FIGS. 4 through 7 are views illustrating various examples of a coupling structure between a lens barrel and a piezoelectric actuator.

FIGS. 8 through 13 are views illustrating various examples of a coupling structure between a housing and a piezoelectric actuator.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

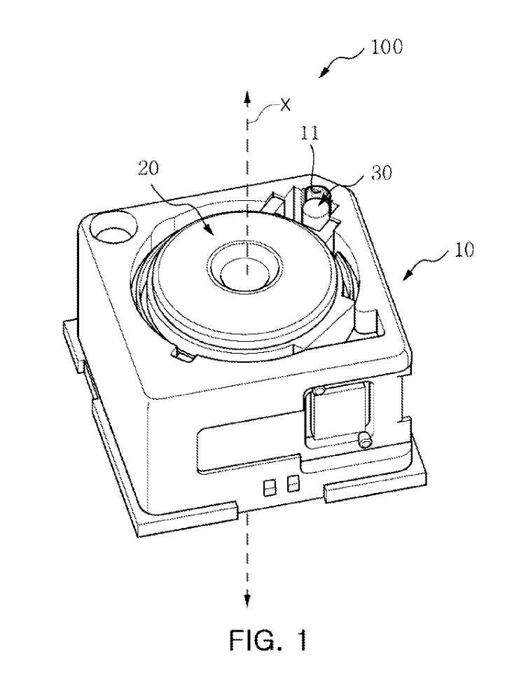

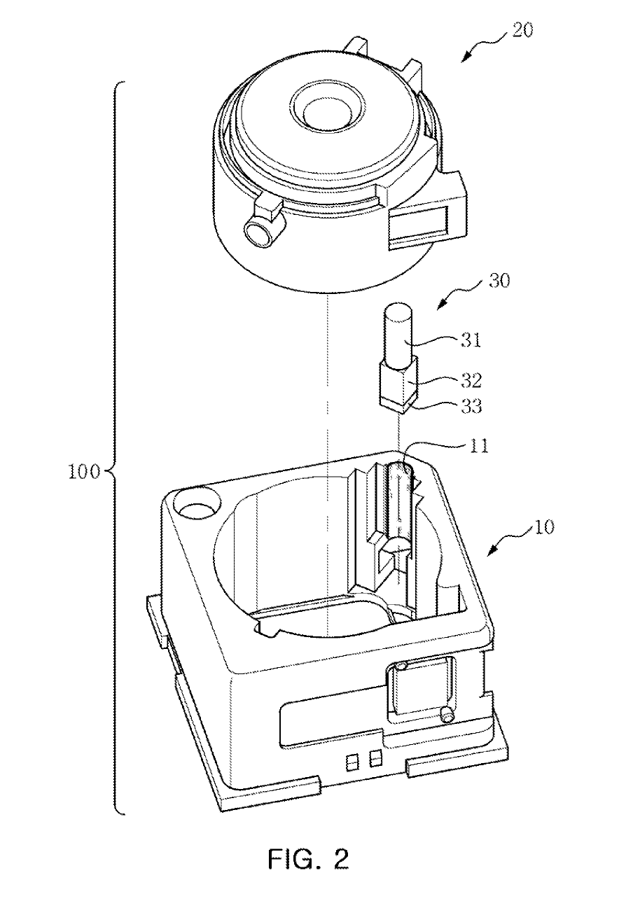

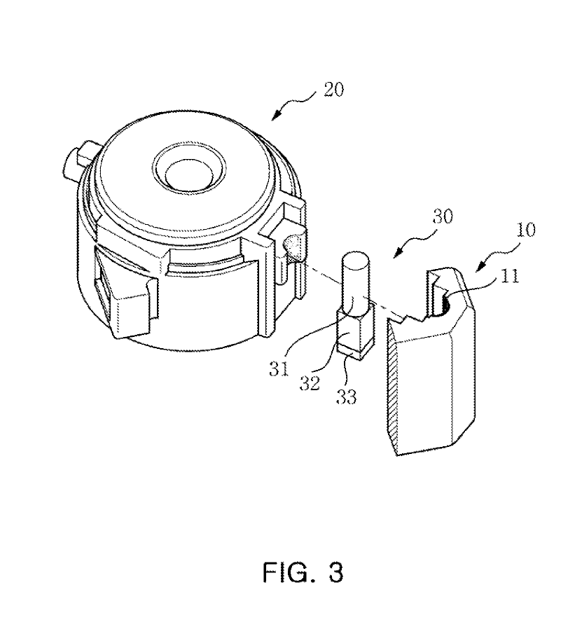

FIG. 1 is a perspective view of a camera module 100, according to an example. FIG. 2 is an exploded perspective view of the camera module 100. FIG. 3 is an exploded perspective view of a lens barrel assembly (including a lens barrel 20 and a piezoelectric actuator 30) and a housing 10 which are coupled to each other, according to an example.

The camera module 100 includes the lens barrel 20 including one or more lenses (not shown), the housing 10 accommodating the lens barrel 20 in an internal space thereof, and the piezoelectric actuator 30 formed on an inner surface 11 of the housing 10 and configured to generate a driving force to drive the lens barrel 20 in an optical axis direction X in the internal space of the housing 10. The piezoelectric actuator 30 is coupled to the inner surface 11 of the housing 10 through attractive force of a magnetic material.

The lens barrel 20 may have a hollow cylindrical shape so that the one or more lenses may be accommodated therein for photographing a subject, and the lenses may be provided in the lens barrel 20 along an optical axis. Lenses having various forms may be inserted into the lens barrel 20, and thus light incident through the lenses may be collected in an image sensor (not illustrated), whereby an image may be photographed. The shape and kind of the lens barrel 20 illustrated in FIGS. 1 through 3 are merely examples. That is, the shape and kind of the lens barrel 20, according to example embodiments, are not particularly limited, and may be modified by those skilled in the art.

The housing 10 encloses the lens barrel 20 to protect other lens assemblies from external impacts of the lens barrel 20, and prevent introduction of foreign materials, thereby stably maintaining and improving driving performance of the camera module 100. In the camera module 100, the piezoelectric actuator 30 forms a driving part for driving the lens barrel 20 in the optical axis direction X, thereby effectively driving the lens barrel 20 in the internal space of the housing 10.

In a case in which voltage is applied to the piezoelectric actuator 30, the piezoelectric actuator 30 may apply driving force generated by repeated contraction or expansion of a piezoelectric element 32 included in the piezoelectric actuator 30 to the lens barrel 20. The piezoelectric element 32 may use a phenomenon that electrical polarization occurs when external force is applied to cause mechanical deformation, and when voltage is applied thereto, the piezoelectric element 32 may move or generate force. When voltage is applied to the piezoelectric element 32, vibrations may be generated in the piezoelectric element 32, and may be transferred to the lens barrel 20, and thus the lens barrel 20 may move in upward and downward optical axis directions X.

As illustrated in FIG. 3, the piezoelectric actuator 30 may be coupled to the lens barrel 20 and the inner surface 11 of the housing 10 corresponding to the lens barrel 20 within the housing 10. The piezoelectric actuator 30 may be coupled to the inner surface 11 of the housing 10 through attractive force by magnetic force rather than a bonding method or an adhering method when it is coupled to the inner surface 11 of the housing 10. In a case in which the piezoelectric actuator 30 is fixedly coupled to the inner surface 11 of the housing 10 by the bonding method or other adhering methods, vibrations generated in the piezoelectric actuator 30 may not be effectively transferred to the lens barrel 20. In a case in which the piezoelectric actuator 30 is coupled to the inner surface 11 of the housing 10 through the attractive force by the magnetic force, a displacement width of the vibrations generated in the piezoelectric actuator 30 may be increased, and thus efficiency of driving force transferred to the lens barrel 20 may be significantly increased, whereby driving reliability of the camera module 100 may be increased, power consumption of the camera module 100 may be effectively decreased, and durability of the piezoelectric actuator 30 may be ensured.

In addition, the piezoelectric actuator 30 may also be closely adhered and coupled to the lens barrel 20, whereby upward driving force of the piezoelectric actuator 30 may be effectively transferred to the lens barrel 20. According to the related art, in a case of a preload structure in which the piezoelectric actuator 30 is closely adhered to the lens barrel 20 by a separate member such as a leaf spring, a separate component may be inserted, and thus a manufacturing process of the camera module may be complicated and productivity may be decreased. Furthermore, in the case of the preload structure by the separate member, when a plurality of vibrations are repeatedly performed, the preload structure between the piezoelectric actuator 30 and the lens barrel 20 may become loose or be separated, and thus driving reliability of the lens barrel 20 may be rapidly decreased. Therefore, in an example, coupling between the piezoelectric actuator 30 and the lens barrel 20, as well as securing coupling force between the piezoelectric actuator 30 and the inner surface 11 of the housing 10, may be made through a coupling structure by the magnetic force rather than a fixing method such as the bonding method, and thus the driving force of the piezoelectric element 32 may be effectively transferred to a rod 31 and the lens barrel 20. In addition, a preload structure effectively implementing friction between coupled surfaces of the lens barrel 20 and the piezoelectric actuator 30 may be formed to ensure reliability of driving performance of the lens barrel 20.

As illustrated in FIG. 2, the piezoelectric actuator 30 includes the rod 31 configured to transfer driving force to the lens barrel 20 in the optical axis direction X, and the piezoelectric element 32 coupled to one end of the rod 31 in order to generate the driving force of the rod 31. The rod 31 may be closely adhered and coupled to one side surface of the lens barrel 20 so that a friction surface is formed between the rod 31 and the lens barrel 20, in order to transfer the driving force of the piezoelectric actuator 30 to the lens barrel 20. In this case, the rod 31 is also coupled to the inner surface 11 of the housing 10 through attractive force by magnetic force. When voltage is applied to the camera module to drive the piezoelectric element 32, the driving force is transferred to the rod 31 coupled to one end of the piezoelectric element 32 to drive the lens barrel 20, on which the friction surface with respect to the rod 31 is formed, in the upward and downward optical axis directions X. A weighted body 33 is further coupled to the other end of the piezoelectric element 32. The weighted body 33 is coupled to the other end of the piezoelectric element 32 to appropriately move the center of gravity of the piezoelectric element 32 that is driven and displaced, thereby more effectively driving the rod 31 and the lens barrel 20 coupled to the rod 31.

Hereinafter, various examples of a coupling structure between the piezoelectric actuator 30 and the lens barrel 20 and a coupling structure between the piezoelectric actuator 30 and the inner surface 11 of the housing 10 will be described with reference to the accompanying drawings.

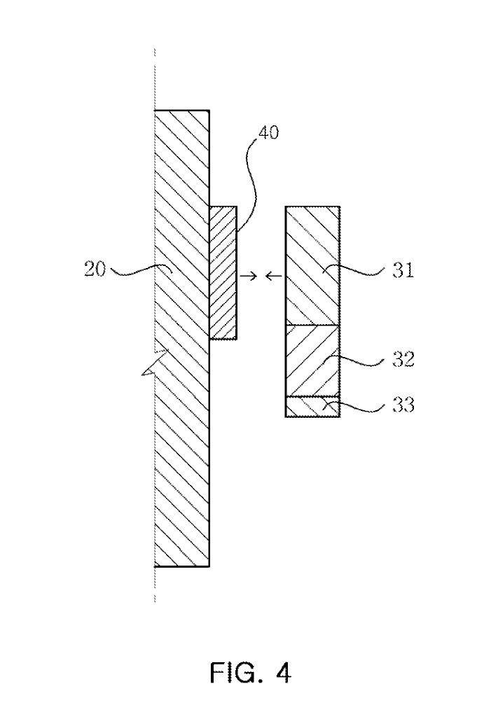

First, FIGS. 4 through 7 are views illustrating various examples of a coupling structure for coupling the lens barrel 20 and the piezoelectric actuator 30 to each other through attractive force of a magnetic material.

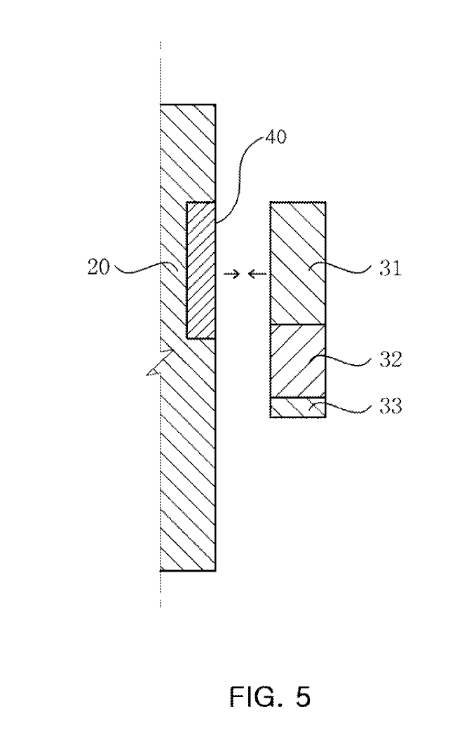

As illustrated in FIG. 4, a magnetic member 40 is coupled to the lens barrel 20, and the rod 31 of the piezoelectric actuator 30 is coupled to the magnetic member 40 through attractive force of a magnetic material. In this case, the rod 31 may be formed of a metal to be coupled to the magnetic member 40 disposed on the lens barrel 20, such as a magnet through attractive force. Here, the magnetic member 40 may be provided as a separate member and be coupled to the outer surface of the lens barrel 20, or may be formed integrally with the outer surface of the lens barrel 20, as illustrated in FIG. 5. When the lens barrel 20 is manufactured, the magnetic member 40 may be formed integrally with the outer surface of the lens barrel 20 coupled to the piezoelectric actuator 30.

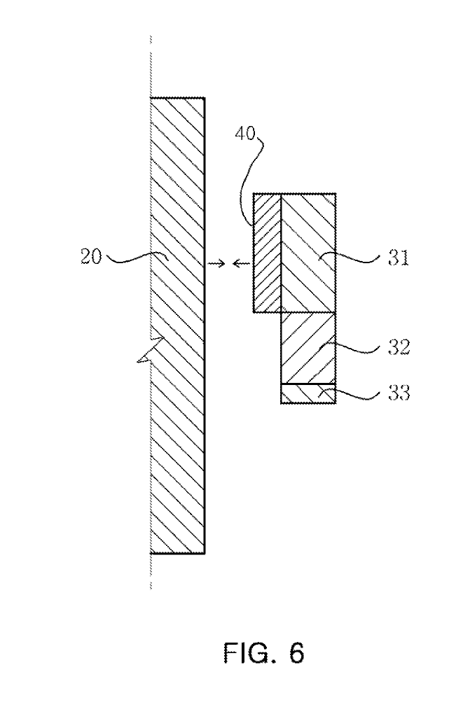

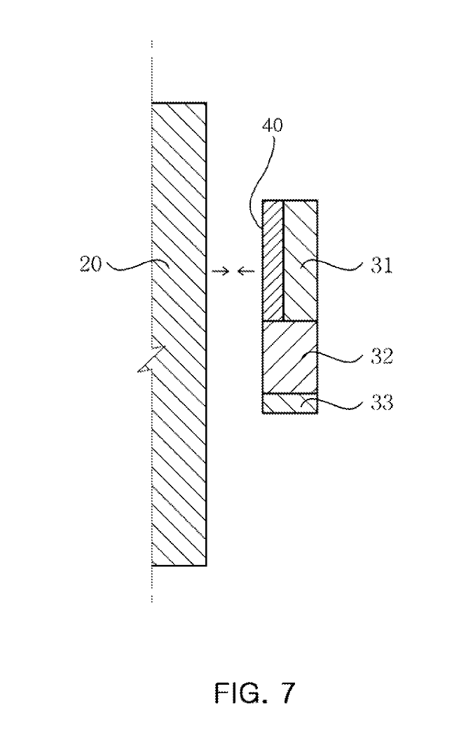

In addition, as illustrated in FIG. 6, the magnetic member 40 corresponding to a material of the outer surface of the lens barrel 20 may be provided as a separate member and be coupled to the piezoelectric actuator 30. According to the example of FIG. 6, the magnetic member 40 is coupled to the outer surface of the rod 31 of the piezoelectric actuator 30. The lens barrel 20 may be formed of an injection-molded material. In this case, the magnetic member 40 is formed in a position corresponding to that of the lens barrel 20 including a material such as a metal, or the like, to generate attractive force. Here, the magnetic member 40 may be provided as a separate member and be coupled to the rod 31, or, as illustrated in FIG. 7, may be formed integrally with the rod 31 through injection molding, or the like, when the piezoelectric actuator 30 is manufactured.

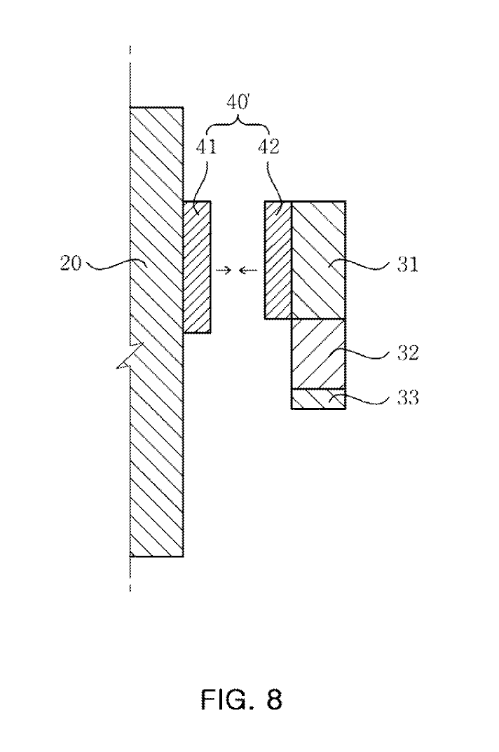

As illustrated in FIG. 8, a magnetic member 40′ may include first and second magnetic members 41 and 42 having opposite poles and coupled to the outer surfaces of the lens barrel 20 and the piezoelectric actuator 30, respectively, and thus the magnetic members 41 and 42 may be coupled to each other through attractive force of a magnetic material. For example, in a case in which the first magnetic member 41 has an N-pole, the second magnetic member 42 has an S-pole, and thus the attractive force is generated between the first and second magnetic members 41 and 42.

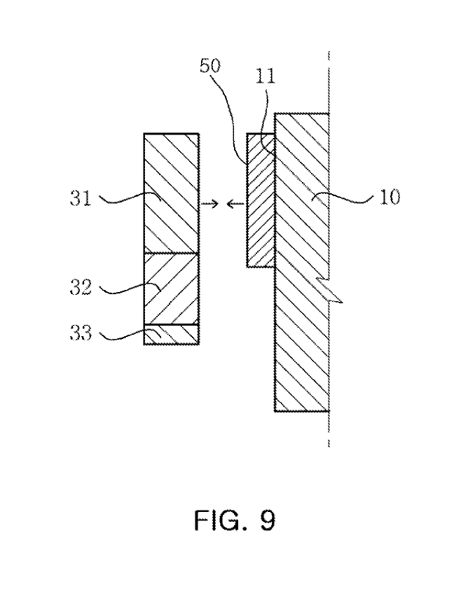

Next, FIGS. 9 through 13 are views illustrating various examples of a coupling structure for coupling the housing 10 and the piezoelectric actuator 30 to each other through attractive force of a magnetic material.

As described above, in the case in which the piezoelectric actuator 30 is coupled to the inner surface 11 of the housing 10 by a bonding method, it may be difficult to effectively transfer displacement of the piezoelectric actuator 30 generated by the piezoelectric element 32 to the lens barrel 20. In the case in which the piezoelectric actuator 30 is coupled to the inner surface 11 of the housing 10 by the bonding method, even if the piezoelectric actuator 30 is coupled to the inner surface 11 of the housing 10 by a flexible elastic adhesive, or the like, a displacement width of vibrations of the piezoelectric element 32 may be limited, and thus voltage equal to or higher than voltage required for driving the lens barrel 20 in the optical axis direction X may be applied to the piezoelectric actuator 30, or reliability in controlling displacement of the lens barrel 20 in the optical axis direction X may be decreased. Therefore, a coupling structure for coupling the piezoelectric actuator 30 to the inner surface 11 of the housing 10 through the attractive force of a magnetic member 50 or 50′ may be formed to implement the displacement width of the piezoelectric actuator 30 to be substantially the same as that of the piezoelectric element 32, whereby reliability of driving displacement of the lens barrel 20 receiving the driving force from the piezoelectric element 32 may be ensured.

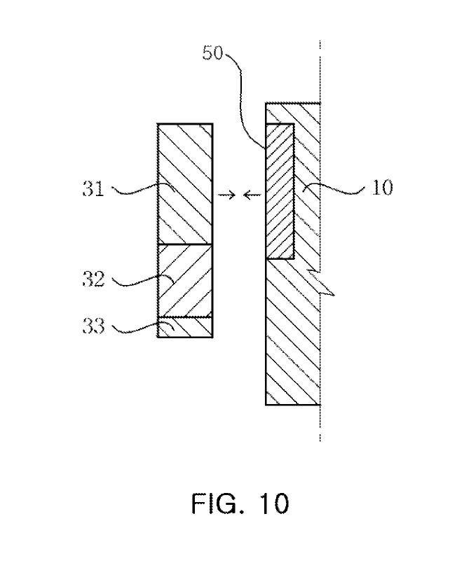

First, as illustrated in FIG. 9, the magnetic member 50 may be provided as a separate member and be coupled to the inner surface 11 of the housing 10, and thus the magnetic member 50 and the piezoelectric actuator 30 corresponding to the magnetic member 50 may be coupled to each other through attractive force therebetween. Alternatively, as illustrated in FIG. 10, the magnetic member 50 may be formed integrally with the inner surface 11 of the housing 10. The inner surface 11 of the housing 10 may be manufactured by insert injection molding, and thus the housing 10 may be manufactured integrally with the magnetic member 50.

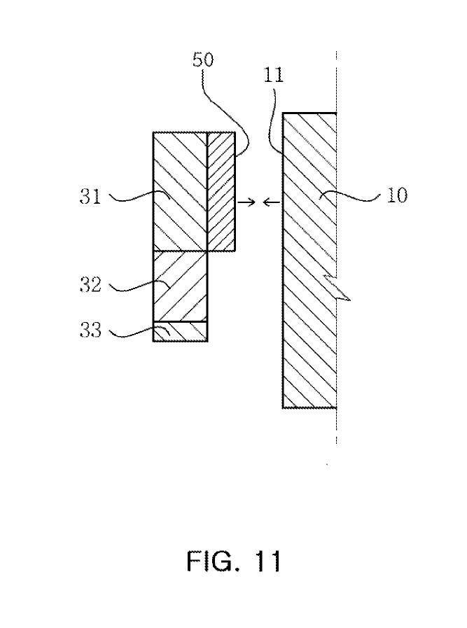

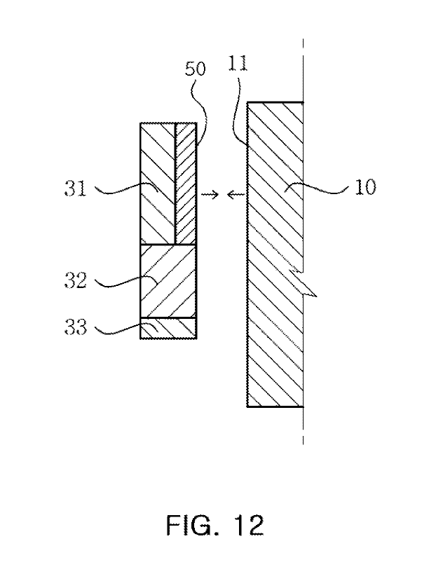

As illustrated in FIG. 11, the magnetic member 50 may be provided as a separate member and be coupled to an outer surface of the piezoelectric actuator 30 corresponding to the inner surface 11 of the housing 10. The housing 10 may be formed of an injection-molded material. In this case, the magnetic member 50 is formed in a position corresponding to that of the housing 10 using a material such as a metal, or the like, to generate the attractive force. Alternatively, as illustrated in FIG. 12, the magnetic member 50 may be formed integrally with the rod 31 of the piezoelectric actuator 30, thereby more effectively implementing this example when the magnetic member 50 is manufactured.

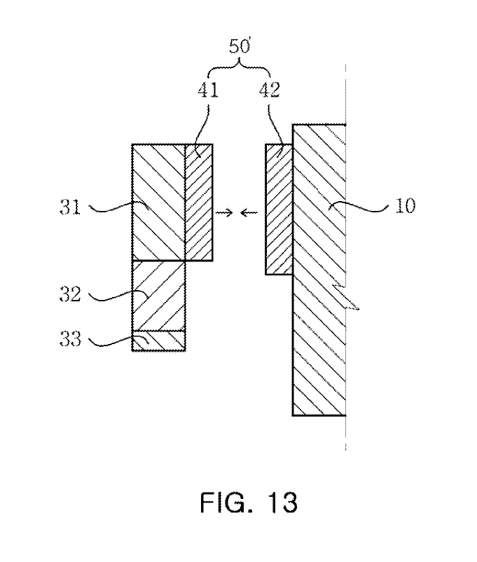

As illustrated in FIG. 13, a magnetic member 50′ may include first and second magnetic members 51 and 52 having opposite poles and coupled to the inner surface 11 of the housing 10 and the outer surface of the piezoelectric actuator 30 corresponding to the inner surface 11 of the housing 10, respectively, and thus the first and second magnetic members 51 and 52 may be coupled to each other through attractive force of a magnetic material. For example, in a case in which the first magnetic member 51 has an N-pole, the second magnetic member 52 has an S-pole, and thus the attractive force is generated between the first and second magnetic members 51 and 52.

As set forth above, according to the examples disclosed herein, the piezoelectric actuator and the inner surface of the housing may be coupled to each other through attractive force of the magnetic members, thereby effectively improving the degree of freedom of a displacement width of the piezoelectric actuator and effectively transferring the driving displacement of the piezoelectric actuator to the lens barrel. Therefore, driving performance and operation reliability of the camera module may be ensured.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a lens barrel including one or more lenses;
a housing accommodating the lens barrel in an internal space thereof; and
a piezoelectric actuator disposed on an inner surface of the housing and coupled to the inner surface of the housing by magnetic force, the piezoelectric actuator being configured to drive the lens barrel in an optical axis direction in the internal space.

2. The camera module of claim 1, wherein the piezoelectric actuator comprises a magnetic member coupling the piezoelectric actuator to the inner surface of the housing through the magnetic force.

3. The camera module of claim 1, comprising a magnetic member disposed on an inner surface of the housing and coupling the inner surface of the housing to the piezoelectric actuator through the magnetic force.

4. The camera module of claim 2, wherein the piezoelectric actuator comprises:
a rod formed of the magnetic member and configured to transfer driving force to the lens barrel in the optical axis direction; and
a piezoelectric element coupled to one end of the rod in order to generate the driving force of the rod.

5. The camera module of claim 2, wherein:
the piezoelectric actuator comprises
a rod configured to transfer driving force to the lens barrel in the optical axis direction, and
a piezoelectric element coupled to one end of the rod in order to generate the driving force of the rod; and
the magnetic member is coupled to a side surface of the rod corresponding to the inner surface of the housing.

6. The camera module of claim 5, wherein the rod and the magnetic member are formed integrally with each other.

7. The camera module of claim 4, wherein the piezoelectric actuator further comprises a weighted body disposed on an end of the piezoelectric element opposing one end of the piezoelectric element on which the rod is disposed.

8. The camera module of claim 4, wherein the magnetic member is formed integrally with the housing by insert injection molding.

9. The camera module of claim 1, further comprising:
first and second magnetic members disposed on the piezoelectric actuator and the inner surface of the housing, respectively, so as to couple the piezoelectric actuator and the housing to each other through the magnetic force,
wherein the first and second magnetic members have opposite poles so that attractive force acts between the first and second magnetic members.

10. The camera module of claim 1, wherein the piezoelectric actuator is coupled to an outer surface of the lens barrel through magnetic force.

11. The camera module of claim 10, wherein the piezoelectric actuator comprises:
a rod configured to transfer driving force to the lens barrel in the optical axis direction;
a piezoelectric element coupled to one end of the rod in order to generate the driving force of the rod; and
a magnetic member coupled to a side surface of the rod corresponding to the outer surface of the lens barrel.

12. The camera module of claim 10, wherein the piezoelectric actuator comprises a magnetic member configured to couple the piezoelectric actuator to the outer surface of the lens barrel.

13. The camera module of claim 10, further comprising:
first and second magnetic members disposed on the piezoelectric actuator and the outer surface of the lens barrel, respectively, so as to couple the piezoelectric actuator and the lens barrel to each other through the magnetic force,
wherein the first and second magnetic members have opposite poles so that attractive force acts between the first and second magnetic members.

14. A camera module comprising:
a lens barrel including one or more lenses;
a housing accommodating the lens barrel in an internal space thereof; and
a piezoelectric actuator disposed on an outer surface of the lens barrel and coupled to the outer surface of the lens barrel by magnetic force, the piezoelectric actuator being configured to drive the lens barrel in an optical axis direction in the internal space.

15. The camera module of claim 14, wherein the piezoelectric actuator comprises a magnetic member configured to couple the piezoelectric actuator to the outer surface of the lens barrel.

16. The camera module of claim 14, further comprising:
first and second magnetic members disposed on the piezoelectric actuator and the outer surface of the lens barrel, respectively, so as to couple the piezoelectric actuator and the lens barrel to each other through the magnetic force,
wherein the first and second magnetic members have opposite poles so that attractive force acts between the first and second magnetic members.
